(19) United States
(12) Patent Application Publication
(10) Pub. No.: US 2008/0094441 A1
(43) Pub. Date: Apr. 24, 2008

(54) APPARATUS AND METHOD FOR ALIGNING LIQUID-JET HEAD

(75) Inventors: Takuma OKAMURO, Fujimi-machi (JP); Motonori Okumura, Shiojiri-shi (JP); Mutsuhiko Ota, Matsumoto-shi (JP); Kazutoshi Goto, Matsumoto-shi (JP); Isao Yanagisawa, Chino-shi (JP); Yasuo Inaoka, Shiojiri-shi (JP)

Correspondence Address: SUGHRUE MION, PLLC, 2100 Pennsylvania Avenue, N.W., Washington, DC, 20037, US

(73) Assignee: Seiko Epson Corporation, Tokyo (JP)

(21) Appl. No.: 11/874,693

(22) Filed: Oct. 18, 2007

(30) Foreign Application Priority Data
Oct. 18, 2006 (JP) 2006-284293

(51) Int. Cl. B41J 29/393

(52) U.S. Cl. 347/19

(57) ABSTRACT

Provided is an alignment apparatus for a liquid-jet head which includes a nozzle plate, a fixation member, a transparent mask, chucks, and an alignment mechanism. The nozzle plate includes a nozzle orifice for injecting a liquid for the liquid-jet head, and a first and a second alignment marks to be used in an aligning operation. Each of the alignment marks is formed in each of two end portions in the longitudinal direction of the nozzle plate. The fixation member holds the nozzle-plate side of each of a plurality of liquid-jet heads. The fixation member and the nozzle plate are positioned relative to each other and joined together by use of the alignment apparatus for the liquid-jet head. The transparent mask includes a first and a second reference marks with which the first and the second alignment marks are to be aligned respectively. The chucks are brought into contact respectively with two end surfaces in the longitudinal direction of each liquid-jet head, and thus hold the liquid-jet head. The alignment mechanism is configured to move the liquid-jet head by use of the chucks linearly within a plane that is parallel to the nozzle plate, and to move the liquid-jet head rotationally about an axis orthogonal to the plane.

The entire disclosure of Japanese Patent Application No. 2006-284293 filed Oct. 18, 2006 is expressly incorporated by reference herein.

### BACKGROUND

1. Technical Field

The present invention relates to an apparatus and a method for aligning a liquid-jet head. The invention is useful especially in a case where the invention is employed in aligning the liquid jet head with accuracy using two alignment marks (reference marks) printed on a mask of a transparent member.

2. Related Art

An ink-jet recording apparatus, such as an ink-jet printer and an ink-jet plotter, is provided with an ink-jet recording head unit (hereinafter, referred to as a head unit) including an ink-jet recording head that ejects ink, in a form of ink droplets, stored in a liquid storage, such as an ink cartridge or in an ink tank. The ink-jet recording head in consideration has a line of nozzles that is formed by nozzle orifices arranged side by side with one another. A side of the ink-jet recording head, precisely, the side from which the ink is ejected, is protected by a cover head. The cover head has a window-frame portion and side-wall portions. The window-frame portion is provided at the ink-ejecting side of the ink-jet recording head, and has opening-window portions that allow the nozzle orifices to be exposed therethrough. Each of the sidewall portions is formed by folding the opening-window portion toward the corresponding side face of the ink-jet recording head. Joining the side-wall portions to the respective side faces makes the cover head fixed to the ink-jet recording head (see, for example, JP-A-2002-160376, esp. P. 4 and FIG. 3).

Incidentally, the positioning of the cover head or fixation members, such as a fixation plate, to a plurality of the ink-jet recording heads, precedes the joining of these members. The positioning is done by moving the ink-jet recording head relative to a nozzle plate so that an alignment mark provided to the nozzle plate can be aligned with a reference mark provided on a plate-shape glass mask.

Ordinarily, two alignment marks are provided, and so are the reference marks. This is because a posture on a plane is uniquely determined by two given positions. Accordingly, in an alignment operation, firstly, one of the alignment marks (a first alignment mark) is aligned with the corresponding one of the reference marks (a first reference mark), and then, the second alignment mark is aligned with the second reference mark.

The distance between the reference mark and the alignment mark has to be as small as possible when the positioning needs accuracy. For this purpose, a method is proposed in which the alignment is carried out while the nozzle plate is in close contact with the glass mask (see, for example, JP-A-2004-345281, esp. P. 10 and FIG. 3).

The ink-jet recording head has to be moved to make the second alignment mark be aligned with the second reference mark after the alignment of the first alignment mark with the first reference mark. In that moment, inconveniences may possibly occur. For example, the first alignment mark that has been aligned with the reference mark is moved to be misaligned. In this case, repeating the positioning operation is needed, and a problem arises. The troublesome alignment operation may possibly take a lot of time.

In addition, when the nozzle plate is closely brought into contact with the glass mask, a foreign object may possibly be sandwiched in between. The foreign object may scratch the surface of the glass mask and the like.

The glass mask and the nozzle plate can be arranged with a space to solve the above-described problem. In this case, however, the above-mentioned space makes the distance between the reference mark and the alignment mark larger, and the larger distance negatively affects the positioning accuracy. As the distance between the reference mark on the glass mask and the alignment mark on the nozzle plate becomes larger, observing the two marks simultaneously with a single optical system needs a larger depth of field. As the depth of field becomes larger, raising the power of the optical system becomes more difficult. This is an obstacle to be removed when the positioning accuracy needs to be made higher.

Such problems as the ones that occur in the case of the alignment in the manufacturing of the ink-jet recording head unit may also arise in the case of the alignment in the manufacturing of other types of liquid-jet head unit.

### SUMMARY

An advantage of some aspects of the invention is providing an apparatus and a method to help a liquid-jet head achieve an easy, quick, and highly-accurate alignment operation between the reference mark and the alignment mark.

A first aspect of the invention provides an alignment apparatus for a liquid-jet head which includes a nozzle plate, a fixation member, a transparent mask, chucks, and an alignment mechanism. The nozzle plate includes a nozzle orifice for injecting a liquid for the liquid-jet head, and a first and a second alignment marks to be used in an aligning operation. Each of the alignment marks is formed in each of two end portions in the longitudinal direction of the nozzle plate. The fixation member holds the nozzle-plate side of each of a plurality of liquid-jet heads. The fixation member and the nozzle plate are positioned relative to each other and joined together by use of the alignment apparatus for the liquid-jet head. The transparent mask includes a first and a second reference marks with which the first and the second alignment marks are to be aligned respectively. The chucks are brought into contact respectively with two end surfaces in the longitudinal direction of each liquid-jet head, and thus hold the liquid-jet head. The alignment mechanism is configured to move the liquid-jet head by use of the chucks linearly within a plane that is parallel to the nozzle plate, and to move the liquid-jet head rotationally about an axis orthogonal to the plane.

According to the first aspect, the first alignment mark can be aligned with the first reference mark by a liner movement of the liquid-jet head within the plane while the second alignment mark can be aligned with the second reference mark by a rotational movement of the liquid-jet head about the orthogonal axis. In other words, a predetermined positioning operation can be carried out with certainty by combining a liner movement of the liquid-jet head within the plane with a rotational movement about the orthogonal axis. As a result, the alignment operation can be done easily and quickly.

In this case, it is preferable that the alignment mechanism include an X-stage for moving the liquid-jet head by use of the chucks in an X-direction, which is a direction within the plane; a Y-stage for moving the liquid-jet head by use of the chucks in a Y-direction, which is a direction orthogonal to the X-direction; and a θ-stage for moving the X-stage and the Y-stage together rotationally about the axis.

Accordingly, the first alignment mark can be aligned with the first reference mark by moving the liquid-jet head in the X-direction and in the Y-direction while the second alignment mark can be aligned with the second reference mark by moving the liquid-jet head rotationally about the orthogonal axis passing on the center of the first reference mark. In other words, at the positioning operation of the second alignment mark, a predetermined positional relationship between the first alignment mark and the first reference mark does not have to be changed.

As a result, as long as the orthogonal axis passing on the center of the first reference mark has been made in advance to align with the rotational axis of the θ-stage, a predetermined positioning operation can be carried out with certainty by two processes: a process of positioning the first alignment mark and the first reference mark by a movement in the XY-directions, and another process of the second alignment mark and the second reference mark.

In addition, it is preferable that the chucks support the liquid-jet head at least three points.

Accordingly, when the chucks are used to support the liquid-jet head, an unexpected moment that may hinder the maintenance of a favorable supporting state can be prevented in a favorable manner. As a result, the liquid-jet head can be supported stably.

In addition, it is preferable that the alignment apparatus include a spacer jig and a bifocal microscope. The spacer jig is disposed between the fixation member and the mask, with a first surface of the spacer jig being in contact with the fixation member and a second surface thereof being in contact with the mask. Accordingly, when the first and the second reference marks face the first and the second alignment marks respectively, a space can be left in between. The bifocal microscope has an optical axis extending from the opposite side of the mask from the spacer jig, passing through the first and the second reference marks and through the space, and directed towards the first and the second alignment marks. In addition, the bifocal microscope includes a first and a second optical systems that share the optical axis. The first optical system is capable of focusing the first and the second alignment marks while the second optical system is capable of focusing the first and the second reference marks.

Accordingly, the nozzle plate, in which the first and the second alignment marks are formed, does not touch the mask, in which the first and the second reference marks are formed. As a consequence, no scratches are produced on the surfaces of the nozzle plate and the mask. In addition, one of the reference marks and the corresponding one of the alignment marks can be observed by use of the bifocal microscope. A predetermined positioning operation can be carried out by overlapping the images of the reference mark and the alignment mark individually focused by the first optical system and the second optical system respectively. Moreover, in spite of the space that is left between the reference marks and the alignment marks, a larger magnification ratio can be accomplished by making the depth of field for each optical system as small as possible. As a result, the predetermined positioning operation of the liquid-jet head can be carried out with high accuracy.

In addition, it is preferable that the mask include protruding portions which protrude, along the optical axis, towards the alignment marks, and that on top surfaces of the protruding portions, the first and the second reference marks be provided respectively.

Accordingly, the distance from the first and the second reference marks to the first and the second alignment marks can be made shorter. As a consequence, a displacement of the optical axis that is as small as possible can be accomplished. In addition, the member that supports the mask can be made thicker, that is, can have sufficient rigidity. Such a member does not cause any displacement that is due to the bending of the member. As a result, the positioning operation can be carried out with high accuracy.

In addition, it is preferable that the alignment apparatus have a plurality of bifocal microscopes. Such bifocal microscopes have to be disposed with the distance between their optical axes being equal to the distance between the alignment marks of two of the nozzle plates adjacent to each other. With this structure, the plurality of alignment marks formed respectively in the nozzle plates of the plurality of liquid-jet heads can be observed simultaneously.

Accordingly, the positioning of the plurality of the liquid-jet head can be carried out at a time, so that the predetermined positioning operation can be carried out more quickly.

In addition, it is preferable that the optical axis of a bifocal microscope be fixed, and that the mask and a spacer jig which supports the liquid-jet head be made to move as a unit so that the first and the second reference marks as well as the first and the second alignment marks, all of which are subjected to the alignment process, can occupy any one of positions on the optical axis and in the vicinity of the optical axis.

Accordingly, since the optical axis is fixed, the positional adjustment accompanying the movement of the mask and the spacer jig that supports the liquid-jet head can be carried out quickly and with high accuracy. The reason for this is that maintaining the postures of the mask and of the spacer jig is much easier than adjusting the optical axis that is displaced when the optical axis is moved. This is because a slight change in the posture of the optical system causes a large displacement of the optical axis.

A second aspect of the invention provides an alignment method for a liquid-jet head in positioning relative to and joining with each other a nozzle plate and a fixation member. Here, the nozzle plate includes a nozzle orifice for injecting a liquid for the liquid-jet head, and a first and a second alignment marks to be used in an aligning operation. Each of the alignment marks is formed in each of two end portions in the longitudinal direction of the nozzle plate. The fixation member holds the nozzle-plate side of each of a plurality of liquid-jet heads. The method includes an adjustment to make the first alignment mark overlap a first reference mark, with which the first alignment mark is to be aligned. This adjustment is carried out by combining a linear movement of the liquid-jet head within a plane that is parallel to the nozzle plate and a rotational movement of the liquid-jet head about an axis orthogonal to the plane. The method also includes another adjustment to make the second alignment mark overlap a second reference mark with which the second alignment mark is to be aligned.

According to the second aspect, a predetermined positioning operation can be carried out with certainty by combining the movement of the liquid-jet head within the plane and the rotational movement about the orthogonal axis. As a result, the alignment operation can be done easily and quickly.

In this case, it is preferable that the alignment method for a liquid-jet head further include making the first alignment mark be aligned with the first reference mark by a linear movement of the liquid-jet head. In addition it is preferable that the alignment method further include making the second alignment mark be aligned with the second reference mark by a rotational movement of the liquid-jet head about an axis which passes on the center of the first reference mark, and which is orthogonal to the plane.

Accordingly, there is no need to change the predetermined positional relationship between the fist alignment mark and the first reference mark when the positioning operation of the second alignment mark is carried out. The predetermined positioning operation can be carried out with certainty by two processes: a process of positioning the first alignment mark and the first reference mark, and another process of positioning the second alignment mark and the second reference mark. As a result, the predetermined alignment operation can be done easily and quickly.

### BRIEF DESCRIPTION OF THE DRAWINGS

The invention will be described with reference to the accompanying drawings, wherein like numbers reference like elements.

FIG. 1 is an exploded perspective view of a head unit to be subjected to a predetermined alignment operation according to an embodiment.

FIG. 2 is a perspective view of the head unit in an assembled state.

FIG. 3 is a cross-sectional view of a principal part of the head unit.

FIG. 4 is an exploded perspective view of a principal part of the head unit.

FIG. 5 is a cross sectional view illustrating a recording head and a head case of the head unit.

FIG. 6 is a cross-sectional view illustrating an alignment apparatus according to an embodiment of the invention.

FIG. 7 is a cross-sectional view taken along the line A-A in FIG. 6.

FIGS. 8A to 8C are explanatory views for describing a positioning method by use of the alignment apparatus shown in FIG. 6.

### DESCRIPTION OF EXEMPLARY EMBODIMENTS

### Ink-Jet Recording Head Unit (Liquid-Jet Head Unit)

Hereinafter, the descriptions will be given of an alignment apparatus according to an embodiment of the invention. Before that, however, descriptions will be given of an example of an ink-jet recording head unit equipped with an ink-jet recording head. The ink-jet recording head is a type of liquid-jet head as an object of the alignment operation.

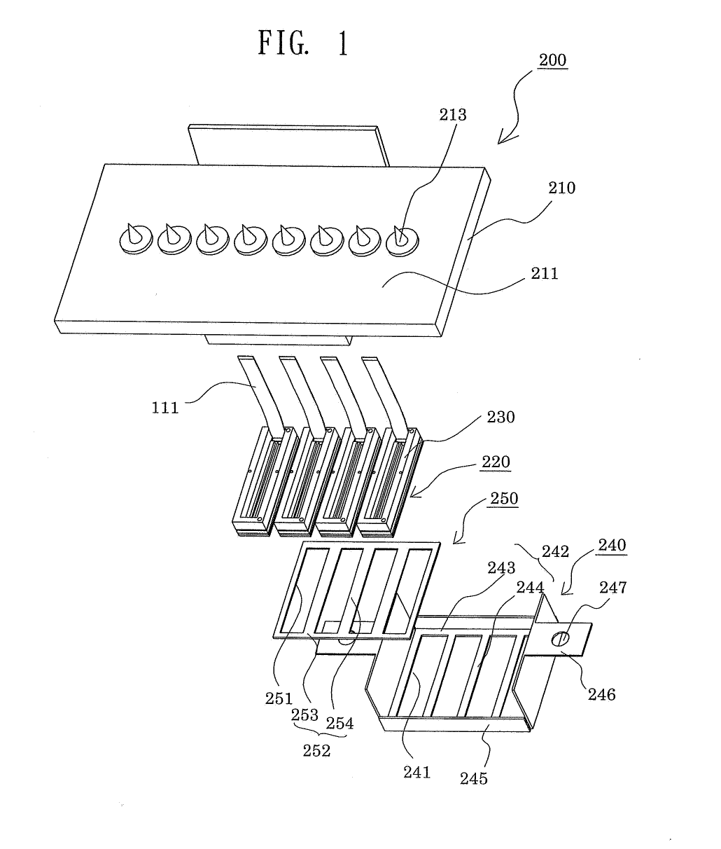

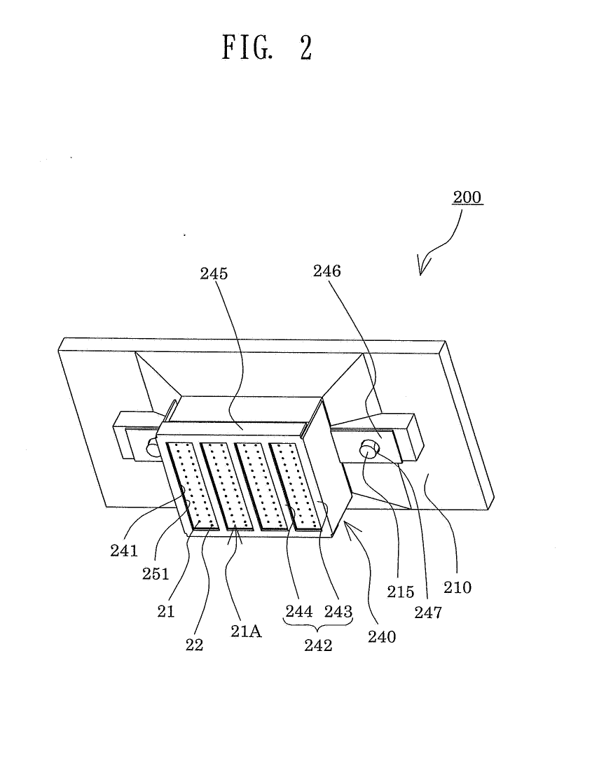

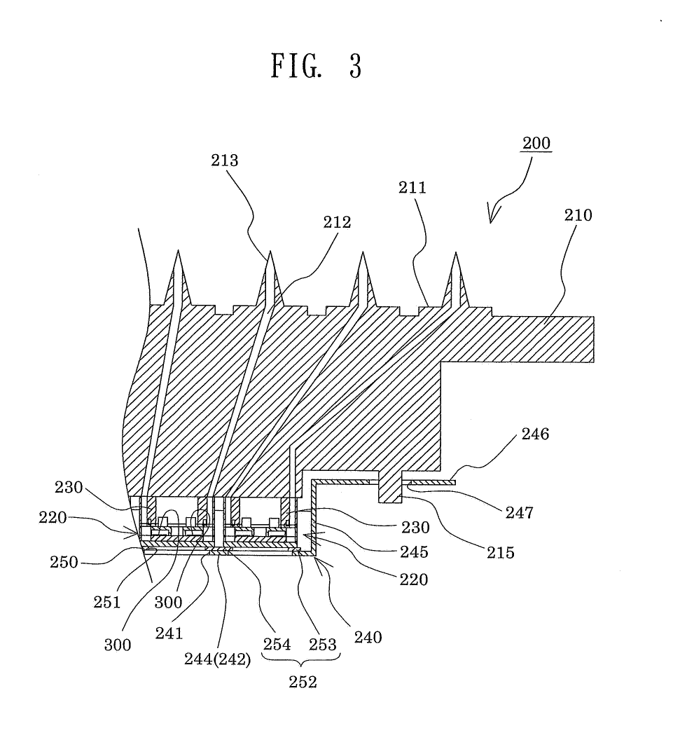

FIG. 1 is an exploded perspective view of an ink-jet recording head unit. FIG. 2 is a perspective view of the ink-jet recording head unit in the assembled state. FIG. 3 is a cross-sectional view of a principal part of the assembled ink-jet recording head unit.

These drawings show that an ink-jet recording head unit 200 (hereinafter simply referred to as the head unit 200) includes a cartridge case 210, an ink-jet recording head 220, a cover head 240, and a fixation plate 250.

The cartridge case 210 is a member for holding ink cartridges, and includes cartridge attaching portions 211, to each of which an ink cartridge (not illustrated) is attached. The ink cartridges are ink supply units formed by separate bodies, and are filled with, for example, inks of black and three colors respectively. In other words, the ink cartridges of these colors are attached respectively to the cartridge cases 210.

FIG. 3 clearly shows that a plurality of ink communicating paths 212 are formed in the cartridge case 210. Each ink communicating path 212 has an opening end to the corresponding cartridge attaching portion 211, and another opening end to a corresponding one of head cases 230. Ink supply needles 213 are inserted into respective ink supply ports of the ink cartridges. Each ink supply needle 213 is fixed to the corresponding one of the opening portions, formed in the cartridge attaching portions 211, of the ink communicating paths 212. When the ink supply needle 213 is fixed to the opening, a filter (not illustrated) is interposed in between. The filter is used in the ink communicating path 212 to remove bubbles and foreign objects that exist in the ink.

The head cases 230 are fixed onto the bottom face of the cartridge case 210. The ink-jet recording head 220 includes a plurality of piezoelectric elements 300. Nozzle orifices 21 are provided in the opposite end face of the ink-jet recording head 220 from the cartridge case 210. Ink droplets are ejected from the nozzle orifices 21 when the piezoelectric elements 300 are driven. The ink-jet recording heads 220 are provided in a plural number that reflects the number of ink colors, and each of the ink-jet recording heads 220 ejects the ink of one of the colors. The head cases 230 that correspond respectively to the ink-jet recording heads 220 are also provided in the plural number independently.

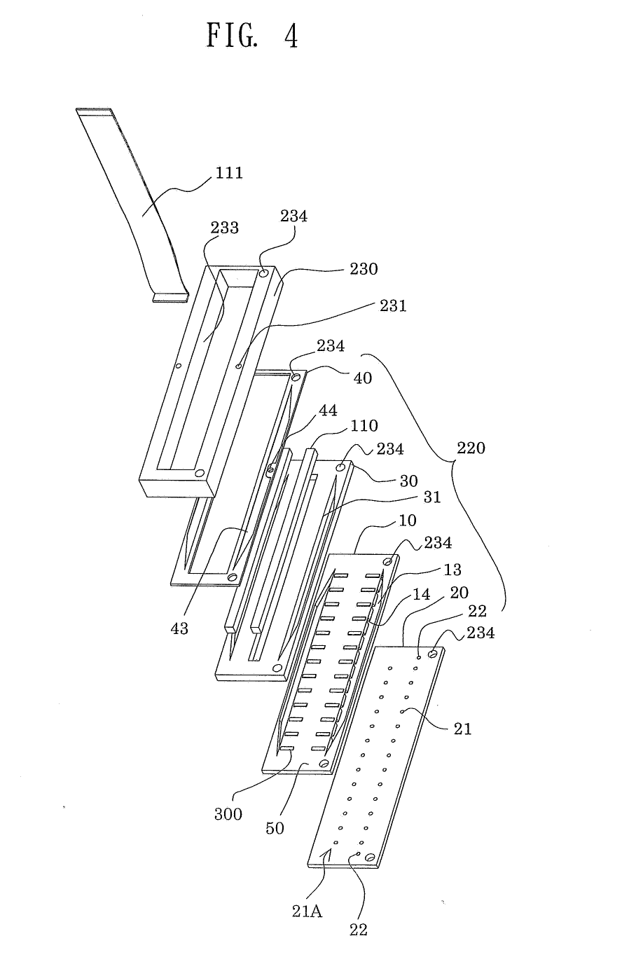

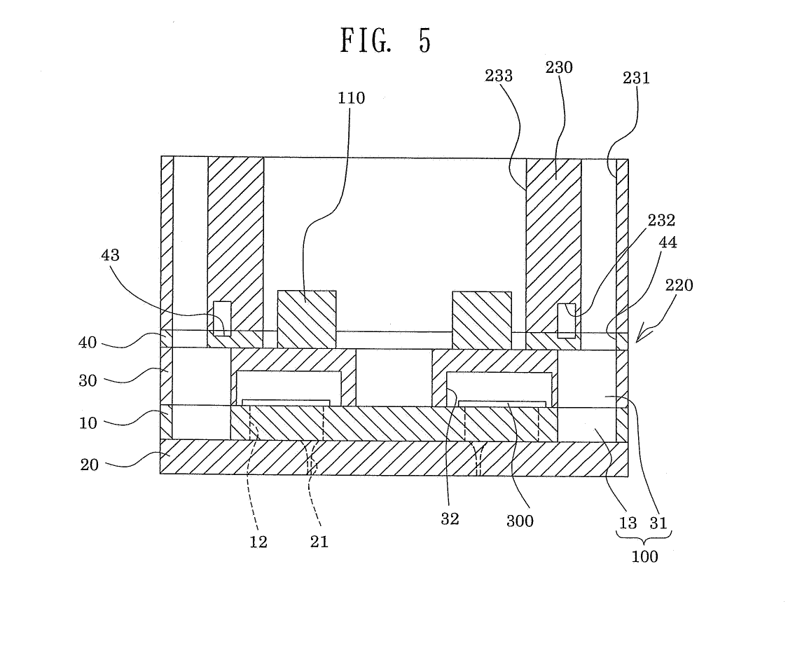

Details of the ink-jet recording heads 220 and the head cases 230 are now described. For this purpose, refer also to FIG. 4 and FIG. 5. FIG. 4 is an exploded perspective view of a principal part of the ink-jet recording head unit 200. FIG. 5 is a cross-sectional view showing one of the ink-jet recording head 220 and the corresponding one of the head case 230.

FIG. 4 and FIG. 5 show that the ink-jet recording head 220 includes four plates: a nozzle plate 20, a passage-forming substrate 10, a protective plate 30, and a compliance plate 40. The passage-forming substrate 10 in this example is made of a single crystal silicon substrate. An elastic film 50, made of silicon dioxide produced by thermal oxidization that has been performed in advance, is formed on a first surface of the passage-forming substrate 10. In the passage-forming substrate 10, pressure generating chambers 12 are formed as being partitioned by a plurality of compartment walls. The pressure-generating chambers 12 in this example are formed by an anisotropic etching performed from the second-surface side of the passage-forming substrate. The pressure generating chambers 12 thus formed are arranged in two lines side by side with each other in the width direction of the passage-forming substrate 10. A communicating portion 13 is formed at the outer side in the longitudinal direction of each of the pressure-generating chambers 12 that are arranged in each one of the two lines. The communicating portion 13 communicates with a reservoir portion 31 formed in the protection plate 30, which is described later. The communicating portion 13 and the reservoir portion 31 together form a reservoir 100, which serves as a common ink chamber for the pressure generating chambers 12 of each line. Ink supply paths 14 are provided to allow the communicating portion 13 to communicate with the respective pressure generating chambers 12—specifically, with an end portion in the longitudinal direction of each pressure generating chamber 12.

The nozzle plate 20 is fixed, with an adhesive agent or a thermally welding film, onto a surface of the passage-forming substrate 10 (the surface is referred to as an orifice-side surface). The nozzle plate 20 has the nozzle orifices 21 drilled therein. Each nozzle orifice 21 communicates with the corresponding one of the pressure generating chambers 12 on the opposite side thereof from the ink supply path. Each ink-jet recording head 220 in this example has two nozzle lines 21A, each of which are nozzle orifices 21 arranged adjacent to one another.

The nozzle plate 20 is favorably formed of a glass ceramics, a silicon single-crystal substrate, a stainless steel, or the like while the thickness and the linear thermal expansion coefficient at 300° C. or lower of such a material are, for example, 0.01 to 1 mm and 2.5 to 4.5 [10⁻⁶/° C.] respectively. The nozzle plate 20 has a first and a second alignment marks 22a and 22b, which are used when the positioning operation between the nozzle plate 20 and the fixation plate 250 is carried out (the alignment marks 22a and 22b will be described later in detail). In the nozzle plate 20 of this embodiment, two alignment marks—the first and the second alignment marks 22a and 22b—are provided respectively in the two end portions in the direction in which nozzle orifices 21 of each nozzle line 21A are arranged. The first and the second alignment marks 22a and 22b can be formed easily in a single punching process together with the nozzle orifices 21.

The piezoelectric elements 300 are disposed on the opposite surface of the passage-forming substrate 10 from the orifice-side surface, precisely, on the elastic film 50. Each of the piezoelectric films 300 includes an insulation layer 55 of zirconium oxide, a lower electrode film of a metal, and a piezoelectric layer of lead zirconate titanate (PZT) or the like, and an upper electrode film made of a metal, which layers and films are formed sequentially.

The protective plate 30 is joined onto a side of the passage-forming substrate 10 where the piezoelectric elements 300 are formed. Each reservoir portion 31 in this example is formed so as to penetrate the protective plate 30 in the thickness direction thereof and along the width direction of each pressure generating chamber 12. As described above, the reservoir portion 31 communicates with the communicating portion 13 of passage-forming substrate 10, and the two portions 13 and 31 together form the reservoir 100 serving as the common ink chamber for all the pressure generating chambers 12 in each line. In the protective plate 30, a piezoelectric element holding portion 32 is formed in a region facing the piezoelectric elements 300. The piezoelectric element holding portion 32 has a space that is large enough not to obstruct the movement of the piezoelectric elements 300. The protective plate 30 can be formed using glass, a ceramics, a metal, a plastic or the like, but is preferably made of a material that has approximately the same linear thermal expansion coefficient as that of the passage-forming substrate 10. The protective plate 30 in this example is formed of the same material as that of the passage-forming substrate 10, precisely, a silicon single-crystal substrate.

In addition, drive ICs 110 are provided on the protective plate 30 for driving the piezoelectric elements 300. Each terminal of the drive ICs 110 is connected to each lead wire that is drawn out from each of the individual electrodes of the piezoelectric elements 300. An unillustrated bonding wire or the like are used for the above-mentioned connection. The terminals of the drive ICs 110 are connected to the outside through external wirings 111, such as shown in FIG. 1. For example, flexible print cables (FPC) can be used to this end. The drive ICs 110 can receive such signals as a print signal from the outside through the external wirings 111.

The compliance plate 40 is joined onto the protective plate 30. To supply ink to the reservoirs 100, ink introducing ports 44 are formed as penetrating the compliance plate 40 in the thickness direction thereof in regions facing the reservoirs 100. In the compliance plate 40, the regions facing the reservoirs 100 except for the ink introducing ports 44 are formed in a smaller thickness in the thickness direction of the compliance plate 40. The regions thus formed are flexible portions 43. Each flexible portion 43 seals the corresponding reservoir 100, and gives certain compliance to the inside of the reservoir 100. To be more specific, flexural deformation of the flexible portion 43 is made possible, when necessary, by a recessed portion 232 formed in a region, facing the flexible portion 43, of the head case 230 provided on the compliance plate 40. Note that an ink supply communicating paths 231 are formed in the head case 230.

In the head case 230, a drive IC holding portion 233 is formed as penetrating the head case 233 in the thickness direction thereof. The drive IC holding portion is formed in a region facing the drive ICs 110 provided on the protective plate 30. Each external wiring 111 is inserted into the corresponding drive IC holding portion 233, and is connected with the drive ICs 110.

In the ink-jet recording head 220 with such a structure as mentioned above, the ink from each ink cartridge flows through the corresponding ink communicating path 212 (see FIG. 3) and the corresponding ink supply communicating path 231. Then, the ink is taken in through the ink introducing port 44. The ink thus taken in fills the inside of the section from the reservoir 100 to the nozzle orifices 21. Meanwhile, in accordance with the recording signal from the drive ICs 110, a voltage is applied to the piezoelectric elements 300 that correspond to the respective pressure-generating chambers 12. Then, the elastic film 50 and the piezoelectric elements 300 are flexurally deformed to increase the internal pressure of each pressure-generating chamber 12. Consequently, ink droplets are ejected through the nozzle orifices 21.

Each of the members that form the ink-jet recording head 220 has two pin insertion holes 234 formed respectively in two of the corners thereof. The head case 230 also has such two pin insertion holes 234. The positioning of the members to be assembled is done by inserting a pin into each of the pin insertion holes 234. The members are joined together while the relative positioning of the members is carried out with pins inserted into the two pin insertion holes 234. Thus, the ink-jet recording head 220 and the head case 230 are assembled to form a unit.

Incidentally, the ink-jet recording head 220 is formed in the following manner. First, multiple chips are formed simultaneously on a single silicon wafer, and then the nozzle plate 20 and the compliance plate 40 are adhered thereto to form a unified body. Thereafter, the wafer is divided into pieces each of which corresponds to the passage-forming substrate 10 of a chip size as shown in FIG. 4.

As FIG. 1 to FIG. 3 show, four of the ink-jet recording heads 220 and also four of the head cases 230 are fixed to the cartridge case 210 side by side with one another, at predetermined intervals, in the same direction as the two nozzle lines 21A are arranged in each ink-jet recording head 220. Consequently, eight nozzle lines 21A are provided in the head unit 200.

As described above, the multiplication of the nozzle lines 21A in each of which nozzle orifices 21 are arranged adjacent to one another is accomplished by using a plurality of ink-jet recording heads 220. The above method of multiplying the nozzle lines 21A can better prevent the decrease in yields than in the case where multiple nozzle lines 21A are formed in a single ink-jet recording head 220. The use of the plurality of ink-jet recording heads 220 to multiply the nozzle lines 21A can increase the number of ink-jet recording heads 220 to be obtained from a single silicon wafer. The use of the plurality of ink-jet recording heads 220 can also decrease the area of the silicon wafer that might possibly be wasted otherwise, and, consequently, can contribute to the lowering of the manufacturing costs.

In addition, as shown in FIG. 1 and FIG. 3, these four ink-jet recording heads 220 are positioned and held by a common fixation member—the fixation plate 250—that is joined to the ink-droplet ejection surface of the plurality of ink-jet recording heads 220. The fixation plate 250, which is a flat plate, includes exposure opening portions 251, from which the nozzle orifices 21 are exposed, and a joint portion 252, which defines the exposure opening portions 251 and which is joined to at least the two end portions of the ink-droplet ejection surface of each of the ink-jet recording heads 220.

The joint portion 252 is composed of fixing frame portions 253 and fixing beam portions 254. The fixing frame portions are formed along the perimeter of the ink-droplet ejection surfaces of the plurality of ink-jet recording heads 220. Each of the fixing beam portions 254 is formed as extending between each of the two adjacent exposure opening portions 251. In other words, the exposure opening portions 251 are separated from one another by the fixing beam portions 254. The joint portion 252, which is composed of the fixing frame portions 253 and the fixing beam portions 254, is joined simultaneously to the ink-droplet ejection surfaces of the plurality of ink-jet recording heads 220. In addition, the fixing frame portions 253 of the joint portion 252 are formed to close the pin insertion holes 234, which are used in positioning the members when each ink-jet recording head 220 is manufactured.

Examples of preferable material for the fixation plate 250 are such metals as a stainless steel, glass ceramics, and a single crystal silicon substrate. In addition, to prevent the deformation caused by the difference in thermal expansion between the fixation plate 250 and the nozzle plate 20, the material of the fixation plate 250 preferably has the same thermal expansion coefficient as the material of the nozzle plate 20 does. For example, when the nozzle plate 20 is made of a single crystal silicon substrate, the fixation plate 250 is preferably made of a single crystal silicon substrate, as well.

In addition, the fixation plate 250 is preferably made thin. Specifically, the fixation plate 250 is desirably made thinner than the cover head 240, which will be described later. In the fixation plate 250 that is made thick, the ink tends to remain between the fixing beam portions 254 when wiping is performed on the ink-droplet ejecting surfaces of the nozzle plates 20. To put it other way, the fixation plate 250 that is thinly formed can prevent the ink from remaining on the ink-droplet ejecting surfaces of the nozzle plates 20 when wiping is performed.

Specifically, the thickness of the fixation plate 250 in this example is 0.1 mm. In addition, there is no particular limitation on how to join the fixation plate and the nozzle plates 20. A favorable joint can be accomplished using a thermosetting epoxy adhesive agent, or a UV curing adhesive agent.

As described above, the fixation plate 250—precisely, the fixing beam portions 254—seals the gap between the adjacent ink-jet recording heads 220, so that the ink cannot intrude into the gap between the adjacent ink-jet recording heads 220. What is thus prevented is the deterioration, or the destruction, of the ink-jet recording heads 220—specifically, the piezoelectric elements 300, the drive ICs 110, and the like—which would otherwise be caused by the ink. Moreover, the adhesive agent fills the gap between the fixation plate 250 and the ink-droplet ejecting surface of the ink-jet recording heads 220 so that no space is left in between. Consequently, the recording medium is prevented from entering the in-between space, so that the deformation of the fixation plate 250 and the paper jam can be prevented from occurring.

As described above, the head unit 200 has four of the ink-jet recording heads 220 fixed to the fixation plate 250. The positioning of these ink-jet recording heads 220 relative to the fixation plate 250 is carried out using an alignment apparatus that will be described later.

In addition, as FIG. 1 and FIG. 2 show, the box-shaped cover head 240, which covers the ink-jet recording heads 220, is provided to the head unit 200 on the opposite side of the fixation plate 250 from the ink-jet recording heads 220. The cover head 240 includes a fixation portion 242 in which opening portions 241 are formed corresponding to the exposure opening portions 251 of the fixation plate 250. The cover head 240 also includes side-wall portions 245 formed, by being bent, around the perimeter of the fixation plate 250 by the side of the side surfaces of the ink-droplet ejecting surfaces of the ink-jet recording head 220.

The fixation portion 242 is composed of frame portions 243 and beam portions 244, which are formed corresponding respectively to the fixing frame portions 253 and the fixing beam portions 244 of the fixation plate 250. Each beam portion 244 separates one of the opening portions 241 from another. The fixation portion 242 composed of the frame portions 243 and the beam portions 244 is joined with the joint portion 252 of the fixation plate 250.

As described above, the ink-droplet ejecting surfaces of the ink-jet recording heads 220 and the cover head 240 are joined together with no space left in between. Consequently, the recording medium is prevented from entering the in-between space, so that the deformation of the cover head 240 and the paper jam can be prevented from occurring. In addition, the side wall portions 245 of the cover head 240 cover the perimeter edge portions of the plurality of ink-jet recording heads 220. Accordingly, the ink is prevented from flowing around to the side surfaces of the ink-jet recording heads 220 with certainty.

Metals such as a stainless steel are examples of the material for the cover head 240. The cover head 240 can be formed by stamping a metal plate, or by molding. In addition, the cover head 240 can be connected to the ground when the cover head 240 is made of an electrically conductive metal material.

Moreover, certain strength is needed for the cover head 240 to protect the ink-jet recording heads 220 from an impact caused by wiping and capping. To this end, the cover head 240 has to be formed relatively thick. The cover head 240 in this example has a thickness of 0.2 mm.

Note that there is no limitation how to join the cover head 240 and the fixation plate 250 together. For example, the cover head 240 and the fixation plate 250 can be joined together with a thermosetting epoxy adhesive agent.

In addition, the fixation portion 242 includes flange portions 246. In each of the flange portions 246, a fixing hole 247 is formed to position and fix the cover head 240 to another member. Each flange portion 246 is formed by bending so as to protrude from one of the side wall portions 245 towards the same direction as the surface direction of the ink-droplet ejecting surface. As FIG. 2 and FIG. 3 show, the cover head 240 in the embodiment is fixed to the cartridge case 210, which is a holding member to hold the ink-jet recording heads 220 and the head case 230 therein.

Moreover, as FIG. 2 and FIG. 3 show, protruding portions 215 are formed on the cartridge case 210. The protruding portions 215 protrude towards the ink-droplet ejecting surface side so as to be inserted into the fixing holes 247 of the cover head 240 respectively. After the protruding portions 215 are inserted into the fixing holes 247 of the cover head 240, the fore-end of each protruding portion 215 is heated, and then, is caulked. Thus, the cover head 240 is fixed to the cartridge case 210. The external diameter of each protruding portion 215 formed on the cartridge case 210 is made smaller than the internal diameter of the fixing hole 247 of each flange portion 246. Accordingly, the cover head 240 can be positioned in the surface direction of the ink-droplet ejecting surfaces, and then can be fixed to the cartridge case 210.

In addition, the cover head 240 and the fixation plate 250 with which the plurality of ink-jet recording heads 220 are joined are fixed to each other, while the fixing hole 247 of the cover head 240 and the plurality of nozzle lines 21A are used for the positioning. Here, the positioning of the fixing hole 247 of the cover head 240 and the plurality of nozzle lines 21A can be carried out using the alignment apparatus, which will be described later. However, when the plurality of ink-jet recording heads 220 are positioned and are fixed to the fixing plate 250, the cover head 240 may also be positioned and fixed to the fixing plate 250.

### First Embodiment

Hereinafter, a detailed description of an alignment apparatus according to an embodiment of the invention will be given with reference to drawings. In FIG. 1 to FIG. 5, members with the same reference numerals are the same members.

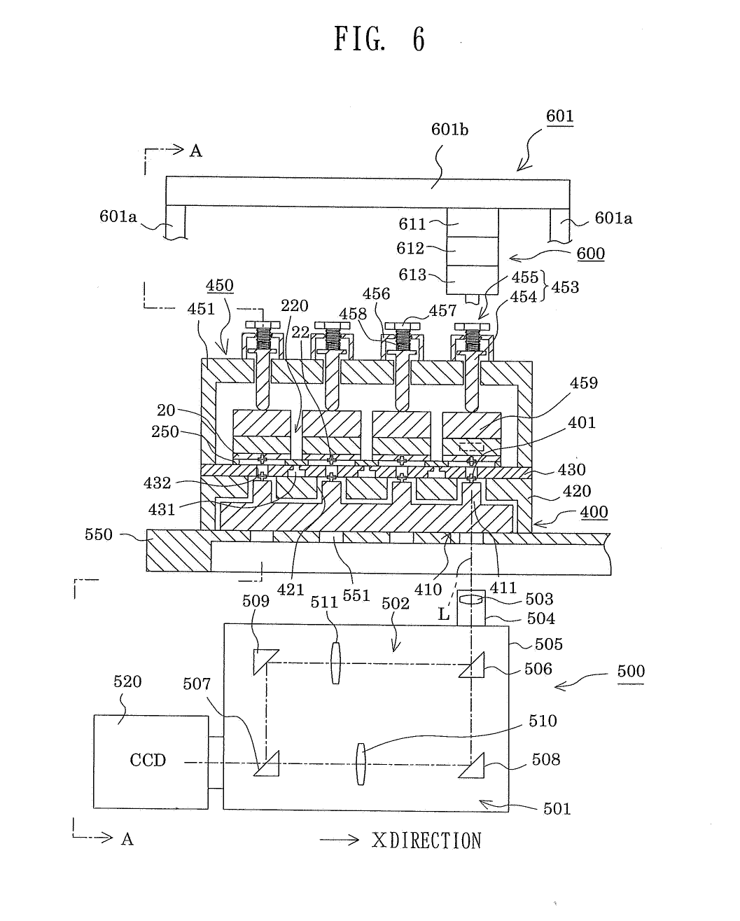

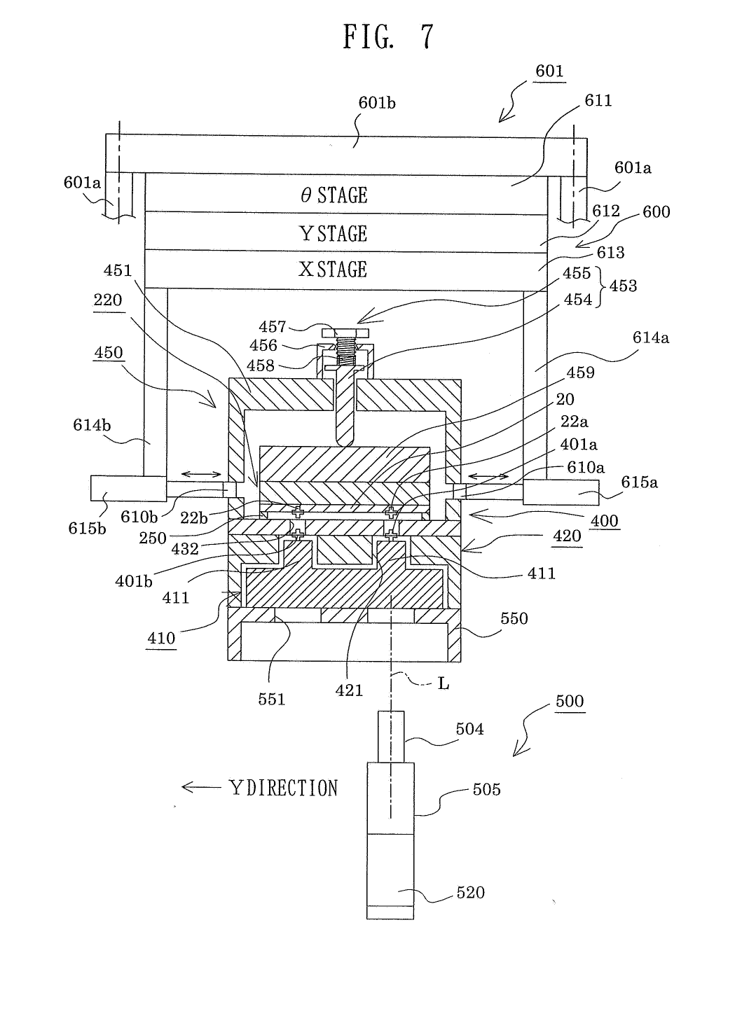

FIG. 6 is a cross-sectional view illustrating an alignment apparatus according to this embodiment. FIG. 7 is a cross-sectional view taken along the line A-A in FIG. 6. As FIG. 6 and FIG. 7 show, the alignment apparatus according to this embodiment includes an alignment jig 400 on which the ink-jet recording heads 220, which are to be aligned, is placed. Also included is a pressing unit 450, which works together with the alignment jig 400 to press the ink-jet recording heads 220 to the fixation plate 250 side. The alignment apparatus also includes a bifocal microscope 500 which has an optical system to observe the ink-jet recording head 220 through the alignment jig 400 from below the alignment jig 400. Also included is a moving stage 550 onto which a mask 410 is fixed and which is capable of moving, when necessary, in the horizontal direction that is perpendicular to the optical axis L of the bifocal microscope 500. Moreover, the alignment apparatus includes an alignment mechanism 600 which aligns the ink-jet recording heads 220 with a predetermined position using chucks 610a and 610b that hold the ink-jet recording head 220.

Among these members, the alignment jig 400 includes the mask 410 provided with a first and a second reference marks 401a and 401b. Also included is a base jig 420 to fix the alignment jig onto the moving stage 550. The alignment jig 400 also includes a spacer jig 430 which holds the fixation plate 250—a fixing member disposed on the base jig 420. With this configuration, the base jig 420 is fixed to the moving stage 550, and the spacer jig 430 is made to hold the fixation plate 250. While the relative positions between the first and the second reference marks 401a and 401b, which are on the mask 410 fixed to the moving stage 550, to the first and the second alignment marks 22a and 22b, which are formed in the nozzle plate 20, are checked using the bifocal microscope 500, the aligning of the first and the second reference marks 401a and 401b with the first and the second alignment marks 22a and 22b is carried out. In addition, the fixation plate 250 and the nozzle plate 20 of the ink-jet recording head 220 are bonded together with an adhesive agent.

Note that the base jig 420 is disposed so as to cover the mask 410, but that there is a slight space between the base jig 420 and the mask 410. The base jig 420 and the mask 410, which are not fixed to each other, may possibly rub against each other to produce a crack or a scratch in the mask 410. The space is provided to prevent such a crack or a scratch.

The base jig 420 is made, for example, of a stainless steel that has a shape of a box with an open bottom side. A single, penetrated hole 421 that penetrates the base jig 420 in the thickness direction thereof is formed in a region facing the first and the second reference marks 401a and 401b. The position of the penetrated hole 421 corresponds to the position of a communicating hole 432 formed in the spacer jig 430, which will be described later.

The material for the mask 410 is a transparent material, for example, glass such as silica glass. The mask 410 in this embodiment has protruding portions 411. The protruding portions 411 protrude inside the penetrated hole 421 of the base jig 420, but not touch the penetrated hole 421. The first and the second reference marks 401a and 401b are respectively formed on the top-end portions of the protruding portions 411. To put it other way, the columnar-shape protruding portions 411 correspond respectively to the first and the second reference marks 401a and 401b. In this embodiment, since the first and the second alignment marks 22a and 22b are formed in the nozzle plate 20 of each ink-jet recording head 220, both of the first reference marks 401a and the second reference marks 401b, one for each, are also provided for every single ink-jet recording head 220. In total, eight reference marks 401a and 401b are provided to each ink-jet recording head 220.

Each of the first and the second reference marks 401a and 401b is preferably formed in a height around the height of each of the first and the second alignment marks 22a and 22b of the nozzle plate 20. The reason for this is making the distance from the first and the second alignment marks 22a and 22b to the first and the second reference marks 401a and 401b smaller to improve the positioning accuracy. By contrast, the larger the distance from the first and the second alignment marks 22a and 22b to the first and the second reference marks 401a and 401b, the more difficult the securing of positioning accuracy becomes. In addition, when the distance from the first and the second alignment marks 22a and 22b to the first and the second reference marks 401a and 401b is large, the optical axis of the optical system is displaced to a large extent by the heat of the metal halide lamp or the like which is used when the position is checked with the optical systems 501 and 502. As a result, regarding the positional relations between the first and the second reference marks 401a and 401b and the first and the second alignment marks 22a and 22b, a large error occurs between the actual relations and the relations observed through the optical systems 501 and 502.

Now, assume that no protruding portion 411 is formed on the mask 410. In this case, when the distance from the first and the second alignment marks 22a and 22b to the first and the second reference marks 401a and 401b is, for example, approximately 5.1 mm, the displacement of the optical axis rises up to approximately 2.5 μm. In this embodiment, however, the protruding portions 411 formed on the mask 410 decrease the distance from the first and the second alignment marks 22a and 22b to the first and the second reference marks 401a and 401b down to 110 μm or lower. The displacement of the optical axis of an optical systems 501 and 502, which is caused by the heat as described above, can be suppressed down to 0.05 μm or lower. As a result, the positioning can be carried out with high accuracy.

Nevertheless, when the protruding portions 411 get too close to the nozzle plate 20, the adhesive agent to bond the nozzle plate 20 and the fixation plate 250 may possibly adhere to the top-end surface of the protruding portion 411. In this case, the observation, using the optical systems 501 and 502, of the first and the second alignment marks 22a and 22b as well as the first and the second reference marks 401a and 401b may become impossible. For this reason, each protruding portion 411 is preferably formed so that its top-end surface can be away from the nozzle plate 20 by a predetermined distance.

As described above, the protruding portions 411 formed on the mask 410 shorten the distance from the first and the second alignment marks 22a and 22b and the first and the second reference marks 401a and 401b. Consequently, it is unnecessary to make the base jig 420 thinner in order to shorten the distance from the first and the second alignment marks 22a and 22b and the first and the second reference marks 401a and 401b. Note that when the base jig 420 is made thinner in order to shorten the distance from the first and the second alignment marks 22a and 22b and the first and the second reference marks 401a and 401b, the following problem occurs. Specifically, when the ink-jet recording heads 220 are pressed onto the fixation plate 250, the base jig 420 is deformed, or destructed. As a result, an error occurs in the alignment of the first and the second reference marks 401a and 401b with the first and the second alignment marks 22a and 22b. In this embodiment, however, because of the protruding portions 411 formed on the mask 410, the base jig 420 does not have to be made thin. The base jig 420 thus maintains certain stiffness that is enough to prevent the deformation and the destruction. As a result, the protruding portions 411 can contribute to the accomplishment of the positioning with high accuracy.

Incidentally, the base jig 420 is detachably held on the moving stage 550. Accordingly, when the fixation plate 250 and the ink-jet recording head 220 are bonded as hardening in one of the alignment jigs 400, the base jig 420 can be used in another one of the alignment jigs 400. As a result, the cost of the alignment jig 400 can be made lower.

The spacer jig 430 holds the fixation plate 250. Spacer jig 430 includes a plurality of suction chambers 431. Each of the suction chambers 431 is made of a plate-shaped member of, for example, a stainless steel. In addition, a suction unit, such as a vacuum pump (not illustrated), is connected to the inside of each suction chamber 431. The suction chamber 431 has an opening on the surface of the spacer jig 430, and holds the surface of the fixation plate 250 by suction. In addition, spaces—specifically, the communicating holes 432—are formed in the spacer jig 430. Through the communicating holes 432, the first and the second alignment marks 22a and 22b of the ink-jet recording head 220 held to the fixation plate 250 by suction can be checked from the bottom surface side of the mask 410 fixed to the moving stage 550. The spacer jig 430 is disposed between the fixation plate 250 and the mask 410 so that the first and the second reference marks 401a and 401b can face the first and the second alignment marks 22a and 22b with a space left in between. To this end, a first surface of the spacer jig 430 touches the fixation plate 250 while a second surface thereof is away, with a slight gap, from the protruding portions 411 of the mask 410 where the first and the second reference marks 401a and 401b are formed. The reason for this structure is to prevent the surface where the first and the second reference marks 401a and 401b are formed from being brought into contact with another member and being scratched by the member.

The pressing unit 450 is disposed in the alignment jig 400 to press the ink-jet recording head 220 towards the fixture plate 250 side. The pressing unit 450 includes an arm portion 451 and pressing portions 453. The pressing unit 450 is a square U-shaped member placed upside down in FIG. 6 over the ink-jet recording heads 220 while two ends of the pressing unit 450 are placed on the spacer jig 430. Each of the pressing portions 453 is provided on the arm portion 451, and press each of the ink-jet recording heads 220 towards the fixture plate 250 side.

The pressing portions 453 are disposed in regions of the arm portion 451, which regions face respectively to the ink-jet recording head 220. In this embodiment, since four of the ink-jet recording heads 220 are fixed to each fixture plate 250, the equal number specifically, four of the pressing portions 453 are provided so as to correspond respectively to the ink-jet recording heads 220.

Each pressing portion 453 is composed of a pressing pin 454, a biasing unit 455, and a pressing piece 459. The columnar pressing pin 454 is inserted into the arm portion 451 and is capable of moving in the axial direction. The biasing unit 455 is disposed on the base-end side of the pressing pin 454 to bias the pressing pin 454 towards the ink-jet recording head 220. The pressing piece 459 is disposed between the pressing pin 454 and the ink-jet recording head 220.

Each of the pressing pins 454 has a hemispheric tip end, which makes a point contact with the top of the pressing piece 459 to press the pressing piece 459.

The biasing units 455 are provided to the arm portion 451 to bias the respective pressing pins 454 towards the ink-jet recording head 220 side. Each of the biasing unit 455 includes: a screw holding member 456, which surrounds the base-end portion of the pressing pin 454; a screw member 457, which screws into the screw holding member 456; and a biasing spring 458, which is provided between the fore-end surface of the screw portion 457 and the base-end portion of the pressing pin 454.

Each of the biasing units 455 thus configured is capable of adjusting the force with which the biasing spring 458 presses the pressing pin 454. The adjustment is done by changing the clamping amount of the screw member 457 to the screw holding member 456. With this configuration, the force with which each pressing pin 454 presses the pressing piece 459 is also made adjustable.

Each of the pressing pieces 459 is disposed between the pressing pin 454 and the protective plate 30 of the ink-jet recording head 220. The pressing pin 454 makes a point contact with the top of the pressing piece 459. Thus, the pressing piece 459 can press the ink-jet recording head 220 while the pressing force of the pressing pin 454 is evenly transmitted to the almost entire top surface of the protective plate 30 of the ink-jet recording head 220. In comparison to the case where the tip end of the pressing pin 454 is brought into direct contact with the top of the protective plate 30 of the ink-jet recording head 220, the pressing of the entire ink-jet recording head 220 by the pressing piece 459 contributes to secure fixation of the ink-jet recording head 220 to the fixation plate 250. Note that the pressing piece 459 has almost the same, or slightly small, size and perimeter shape as those of the protection plate 30 of the ink-jet recording head 220.

The alignment jig 400 that is integrated with the pressing unit 450 as described above is disposed on the moving stage 550, and is configured to be moved, when necessary, in a direction perpendicular to the optical axis L of the bifocal microscope, that is, in the horizontal direction. Accordingly, when the moving stage 550 is moved with the optical axis L being fixed, each of the first and the second alignment marks 22a and 22b of each ink-jet recording head 220, together with the corresponding one of the first and the second reference marks 401a and 401b, can be placed on the optical axis L. Note that in the moving stage 550, penetrated holes 551 are formed in the region through which the optical axis L towards the mask 410 passes. Thus, optical paths to each of the first and the second alignment marks 22a and 22b via the corresponding one of the first and the second reference marks 401a and 401b are secured.

The bifocal microscope 500 a first and a second optical systems 501 and 502, which share the optical axis L. The optical axis extends from the opposite side of the mask 410 from the spacer jig 430 side, passes through the first and the second reference marks 401a and 401b and the communicating hole 432, which is a space, and then is directed towards the first and the second alignment marks 22a and 22b (in the vertical direction in FIG. 6). The optical system 501 is configured to focus the light on the first and the second reference marks 401a and 401b while the optical system 502 is configured to focus the light on the first and the second alignment marks 22a and 22b.

Now, more detail description will be given. An objective lens 503 is housed in a lens barrel 504 in a state where the optical axis L is directed towards the first and the second reference marks 401a and 401b as well as the first and the second alignment marks 22a and 22b. The lens barrel 504A is fixed to a chassis 505, in which two beam splitters 506 and 507, two mirrors 508 and 509, and two focal lenses 510 and 511 are housed.

The optical system 501 includes the beam splitter 506, the mirror 508, the focal lens 510, and the beam splitter 507. The optical path (indicated by a dashed-dotted line in FIG. 6) of the optical system 501 is as follows. The light passing through the beam splitter 506 passes through the focal lens 510, and then reflected off the mirror 508 and the beam splitter 507. Thereafter, the light exit outside of the optical system 501.

The optical system 502 includes the beam splitter 506, the focal lens 511, the mirror 509, and the beam splitter 507. The optical path (indicated by a dashed-dotted line in FIG. 6) of the optical system 502 is as follows. The light reflected off the beam splitter 506 passes through the focal lens 511, and then reflected off the mirror 509 and the beam splitter 507. Thereafter, the light exits outside of the optical system 502.

An imaging unit—specifically, a CCD 520—simultaneously captures an image of the first and the second reference marks 401a and 401b as well as the first and the second alignment marks 22a and 22b through the optical systems 501 and 502. The image thus captured is reproduced. The focused images of the first and the second reference marks 401a and 401b are formed on the CCD by adjusting the focal position of the focal lens 510 while the focused images of the first and the second alignment marks 22a and 22b are formed on the CCD by adjusting the focal position of the focal lens 511. In this way, clear, individually focused images of the first and the second reference marks 401a and 401b as well as of the first and the second alignment marks 22a and 22b can be formed on the CCD 520. An alignment operation is then carried out so as to make these images overlap each other by adjusting the position of the ink-jet recording head 220.

The alignment mechanism 600 has the chucks 610a and 610b which respectively touch the two end surfaces in the longitudinal direction of the ink-jet recording head 220 and which support the ink-jet recording head 220. The alignment mechanism 600 moves the ink-jet recording head 220 within the XY-plane and moves the ink-jet recording head 220 rotationally about the axis orthogonal to the XY-plane with the chucks 610a and 610b. Note that the XY-plane mentioned above is a plane that is parallel to the nozzle plate 20 and the mask 410, that is, a horizontal plane in this embodiment. In addition, the chucks 610a and 610b are formed to support the two end surfaces of ink-jet recording head 220 with three points (specific forms and the like will be described in detail later). This is for the purpose of stabilizing the posture of the ink-jet recording head 220 when the ink-jet recording head 220 is supported with these chucks 610a and 610b.

The alignment mechanism 600 is disposed in a derrick 601 that is formed by a plurality of vertical pillars 601a, and beams 601b each of which is horizontally put up between each two of these pillars. A θ-stage 611, a Y-stage 612, and an X-stage 613 are provided in this order downward from the beam 601b side. The alignment mechanism has two drive cylinders 615a and 615b disposed respectively to the fore-ends of two rods 614a and 614b, which are hanged downward from the lowermost stage, that is, the X-stage 613. Each of the chucks 610a and 610b is fixed to the fore-end of the piston rod of the corresponding one of the drive cylinders 615a and 615b. Driving the drive cylinders 615a and 615b respectively moves the chucks 610a and 610b linearly in the Y-direction within the XY-plane. Accordingly, the chucks 610a and 610b can get closer to or move away from the ink-jet recording head 220. Extending the piston of the drive cylinders 615a and 615b respectively can bring the chucks 610a and 610b into contact with the corresponding one of the two end surfaces in the longitudinal direction of the ink-jet recording head 220. The ink-jet recording heads 220 is supported in this state.

Here, the θ-stage 611 is adjusted in advance to make its axis of the rotational shaft the center of the first reference mark 401a. In addition, the Y-stage 611 is moved in the Y-direction within the XY-plane relative to the θ-stage 611, while the X-stage 613 is moved in the X-direction within the XY plane relative to the Y-stage 612. In this way, the X-stage 613 and the Y-stage 612 are capable of being configured to rotationally move about the rotational axis of the θ-stage 611, that is, about the first reference mark 401a. In addition, the θ-stage 611, Y-stage 612, and the X-stage 613 are fixed to the moving stage 550. The movement of the moving stage 550 moves the ink-jet recording head 220 in the X-direction in FIG. 6. Thus, the θ-stage 611, Y-stage 612, and the X-stage 613 can occupy the position over the ink-jet recording head 220 of each of the lines (four lines in this example).

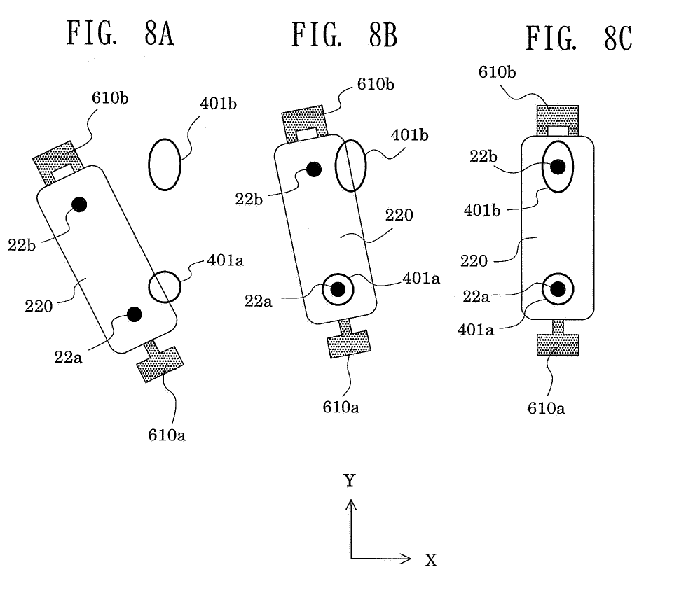

Next, descriptions will be given of a method of aligning the ink-jet recording head 220 to a predetermined position by use of such an alignment apparatus as described above with reference to FIG. 8.

1) Check the first reference mark 401a from the bottom surface side of the alignment jig 400 with the bifocal microscope 500.

2) Make the alignment jig 400 hold the fixation plate 250 by placing and fixing the fixation plate onto the top surface of the spacer jig 430. At this time, the spacer jig 430 vacuums the fixation plate 250 through the suction chambers 431.

3) In the first optical system 501 of the bifocal microscope 500, adjust the focal lens 510 to make a focused image of the first reference mark 401a be captured by the CCD 520. Additionally, in the second optical system 502, adjust the focal lens 511 to make a focused image of the first alignment mark 22a be captured by the CCD 520. Consequently, the CCD 520 captures clear images focused respectively on the first reference mark 401a and the first alignment mark 22a. Though the optical systems 501 and 502 share the optical axis L, the optical systems 501 and 502 can individually focus on respective objects that are located at different positions (the first reference mark 401a and the first alignment mark 22a). Accordingly, a clear image of the first reference mark 401a and that of the first alignment mark 22a can be obtained by setting a small depth of field and thus by a sufficient magnification ratio.

In such a state, as FIG. 8A shows, the two end surfaces in the longitudinal direction of the ink-jet recording head 220 are supported respectively by the chucks 610a and 610b. The fore-end portion of the chuck 610b used here is bifurcated. On the other hand, the chuck 610a is brought into contact with the end surface on the opposite side of the ink-jet recording head 220 from the chuck 610b, on a line passing on the center of the bifurcated fore-end. In short, the chucks 610a and 610b support the ink-jet recording head 220 at three points.

4) From the state shown in FIG. 8A, move the ink-jet recording head 220 that is held by the chucks 610a and 610b within the XY-plane by use of the X-stage 613 and the Y-stage 612. Consequently, as FIG. 8B shows, the first alignment mark 22a is made to occupy the position of the center of the first reference mark 401a, so that the two marks 22a and 401a are made to occupy the same position.

5) Perform the focusing operations 1) to 3) described above on the second alignment mark 22b and the second reference mark 401b in the same manner.

6) Move rotationally the X-stage 613 and the Y-stage 612 as a unit by use of the θ-stage 611. At this time, the position of the rotational axis is previously adjusted to occupy the same position of the center of the first reference mark 401a. Accordingly, the ink-jet recording head 220 rotates about the center of the first reference mark 401a. Consequently, as FIG. 8C shows, the second alignment mark 22b can be brought to the position of the center of the second reference mark 401b. When such a state as has just been described, finish the positioning operation.

7) Bring the ink-jet recording head and the fixation plate 250 into contact with each other with an adhesive agent. The fixation plate 250 used here is positioned and held by the alignment jig 400. Accordingly, when the mask 410 and the ink-jet recording head 220 are positioned, the positioning of the fixation plate 250 and the ink-jet recording head 220 are automatically done as well.

8) Repeat the processes shown in FIG. 8A to FIG. 8C, and sequentially position the plurality of ink-jet recording heads 220 to the fixation plate 250. To put it another way, move the moving stage 550 in the X-direction in FIG. 6 while the optical axis L, the θ-stage 611, the Y-stage 612, and the X-stage 613 remain fixed. Then, repeat the same positioning and fixation operations on the ink-jet recording head 220 next to the ink-jet recording head 220 whose positioning has just been finished.

Join the fixation plate 250 and the plurality of ink-jet recording heads 220 together by hardening the adhesive agent while all these members are being pressed by the pressing unit 450 with a predetermined pressing force.

As has been described above, the fixation plate 250 and the plurality of ink-jet recording heads 220 are positioned and then joined together. Thus, the positioning of the fixation plate 250 and the nozzle lines 21A can be performed with high accuracy. In addition, the ink-jet recording heads 220 are brought into contact with, and then joined to the fixation plate 250, which is a flat plate. Accordingly, the relative positioning of the plurality of ink-jet recording head 220 in the ink-droplet ejection direction is carried out by only joining the plurality of ink-jet recording heads 220 to the fixation plate 250. For this reason, there is no need for the aligning of the plurality of ink-jet recording heads 220 in the ink-droplet ejection direction. In addition, the ink droplets are certainly prevented from landing at unfavorable positions.

In particular, in this embodiment, the mask 410 is provided with the first and the second reference marks 401a and 401b while the nozzle plate 20 is provided with the first and the second alignment marks 22a and 22b. Space is formed by the spacer jig 430 between the mask 410 and the nozzle plate 20. Due to the space, the position in the height direction of the first and the second reference marks 410a and 410b is different from that of the first and the second alignment marks 22a and 22b. In spite of the difference, the first and the second reference marks 410a and 410b as well as the first and the second alignment marks 22a and 22b can be focused by adjusting the two systems of optics—the optical systems 501 and 502. Accordingly, clearer images of the first and the second reference marks 401a and 401b as well as the first and the second alignment marks 22a and 22b can be obtained and positioning operations can be carried out with high accuracy.

### Other Embodiments

The invention is not limited to the embodiment that has been described thus far. There is no more limitation in particular than the alignment apparatus having the following configuration. The ink-jet recording head 220 is supported by the chucks 610a and 610b. In addition, the aligning of the first and the second alignment marks 22a and 22b with the first and the second reference marks 401a and 401b can be carried out by combining a linear movement of the ink-jet recording head 220 within the XY-plane and a rotational movement thereof about an axis orthogonal to the XY-plane. The configuration that has been just mentioned, however, has such an effect as follows. Only an adjustment to make the rotational axis of the rotational movement of the θ-stage occupy the position of the center of the first reference mark 401a is needed to carry out a predetermined alignment operation in an easier and quicker manner. Specifically, all that is necessary is no more than the two processes: a first process of the liner movement, and a second process of the rotational movement.

Note that, as FIG. 8 shows, any of the reference marks may be formed in an elliptic shape (in FIG. 8, the second reference mark 401b has an elliptic shape). This is advantageous because the positional adjustment is carried out firstly by rotationally moving and then by linearly moving the ink-jet recording head 220 (in FIG. 8, in the Y-direction) as the final positional adjustment.

In addition, two of the bifocal microscopes 500 may be employed by arranging the two bifocal microscopes 500 in the Y-axis direction. By such arrangement, a simultaneous observation of the first and the second alignment marks 22a and 22b can be performed. These alignment marks 22a and 22b are formed respectively in the two end portions in the longitudinal direction of the nozzle plate 20 of each ink-jet recording head 220. Note that in this case, the two bifocal microscopes 500 are disposed with the distance between the optical axes L of the respective two bifocal microscopes 500 being made equal to the distance between the first and the second alignment marks 22a and 22b.

According to this embodiment, a predetermined alignment operation for each ink-jet recording head 220 can be carried out with no relative movement of the optical axis L accompanied. This results in an improved workability.

In addition, the bifocal microscopes 500 may be disposed in the number of the ink-jet recording heads 220 so as to make each bifocal microscope 500 be in charge of each line of the plurality of ink-jet recording heads 220. The more the bifocal microscopes 500 are employed, the more quickly the alignment operation can be carried out.

Moreover, in each of the above embodiments, the pressing unit 450 is provided to the alignment jig 400, but the invention is not limited to this configuration. Assume, for example, that a UV-setting adhesive agent is used to join the fixation plate 250 and the ink-jet recording head 220. In this case, the fixation plate 250 and the ink-jet recording head 220 can be joined together by making the fixation plate 250 and the ink-jet recording head 220 that are brought into contact with each other be subjected to a UV-irradiation to set the UV-setting adhesive agent. As a consequence, the pressing unit 450 may be omitted. Although the thermosetting adhesive agent has to be set while the fixation plate 250 and the ink-jet recording head 220 is being pressed against each other with a predetermined pressing force, the UV-setting adhesive agent does not need such pressing at the time of setting. Nevertheless, the fixation plate 250 and the ink-jet recording head 220 can be joined together with higher accuracy by use of the above-mentioned pressing for the purpose of preventing the positions of and ink-jet recording head 220 and of the fixation plate 250 from being displaced from each other.

The use of the UV-setting adhesive agent renders the joining strength relatively weak. The joining strength can be improved by use of an additional thermosetting adhesive agent after the joining of the fixation plate 250 and the ink-jet recording head 220 with the UV-setting adhesive agent. Specifically, a thermosetting adhesive agent is additionally employed to fix the peripheral portion such as the corners that are defined by the fixation plate 250 and the ink-jet recording head 220 that have been joined together by the UV-setting adhesive agent. The joining, which is carried out in this way between the fixation plate 250 and the ink-jet recording head 220, is highly accurate and strong, so that the joining becomes more reliable.

Furthermore, the example in the above embodiments, has the fixation plate 250 made of a flat plate as a fixation member to which the plurality of ink-jet recording heads 220 are joined. The fixation member, however, is not limited to the fixation plate 250. For example, the plurality of ink-jet recording heads 220 may be positioned relative to and joined directly with the cover head 240. Even in this case, the use of the alignment jig 400 can contribute to the accomplishment of the positioning and the joining with high accuracy.

The example in the above embodiments has the ink-jet recording head 220 of a flexural vibration type, but the ink-jet recording head 220 is not limited to this type. For example, the invention is applicable to a vertical vibration type ink-jet recording head, in which layers of a piezoelectric material and an electrode-forming material are alternately formed on top of each other, and in which the layers thus formed are made to be elongated and contracted in the axial direction. Another example to which the invention is applicable is an ink-jet recording head of a type in which ink droplets are ejected by bubbles formed by the heat generated by a heat-generating element. The invention is also applicable to a head unit equipped with an ink-jet recording head of various types including the ones that have been specifically mentioned thus far.

The example in the embodiments described thus far has a head unit equipped with an ink-jet recording head that ejects an ink as a liquid-jet head to be subjected to the alignment operation, but the invention is not limited to this. The invention is generally applicable to the cases where a liquid-jet head unit equipped with a liquid-jet head in a broad range is manufactured. Examples of such a liquid-jet head include: various kinds of recording heads used in image recording apparatuses such as printers; color-material-jet heads used in manufacturing color filters of liquid crystal display devices and the like; electrode-material-jet heads used in forming electrodes of organic EL display devices, FED (Field Emission Display) devices, and the like; and bio-organic-material-jet heads used in manufacturing bio-chips.

What is claimed is:

1. An alignment apparatus for a liquid-jet head comprising:
a nozzle plate which includes a nozzle orifice for injecting a liquid for the liquid-jet head, and a first and a second alignment marks to be used in an aligning operation, each of the alignment marks being formed in each of two end portions in the longitudinal direction of the nozzle plate;
a fixation member which holds the nozzle-plate side of each of a plurality of liquid-jet heads, the fixation member and the nozzle plate being positioned relative to each other and being joined together by use of the alignment apparatus for the liquid-jet head;
a transparent mask including a first and a second reference marks with which the first and the second alignment marks are to be aligned respectively;
chucks which are brought into contact respectively with two end surfaces in the longitudinal direction of each liquid-jet head, and which thus hold the liquid-jet head; and
an alignment mechanism configured to move the liquid-jet head by use of the chucks linearly within a plane that is parallel to the nozzle plate, and to move rotationally about an axis orthogonal to the plane.

2. The alignment apparatus for a liquid-jet head according to claim 1 wherein the alignment mechanism includes:
an X-stage for moving the liquid-jet head by use of the chucks in an X-direction, which is a direction within the plane;
a Y-stage for moving the liquid-jet head by use of the chucks in a Y-direction, which is a direction orthogonal to the X-direction; and
a θ-stage for moving the X-stage and the Y-stage together rotationally about the axis.

3. The alignment apparatus for a liquid-jet head according to claim 1 wherein the chucks support the liquid-jet head at least three points.

4. The alignment apparatus for a liquid-jet head according to claim 1 wherein the mask includes protruding portions which protrude, along the optical axis, towards the alignment marks, and on top surfaces of which protruding portions, the first and the second reference marks are provided respectively.

5. The alignment apparatus for a liquid-jet head according to claim 1 further comprising:
a spacer jig disposed between the fixation member and the mask with a first surface of the spacer jig being in contact with the fixation member and a second surface thereof being in contact with the mask so that, when the first and the second reference marks face the first and the second alignment marks respectively, a space can be left in between; and
a bifocal microscope which has an optical axis extending from the opposite side of the mask from the spacer jig, passing through the first and the second reference marks and through the space, and directed towards the first and the second alignment marks, and which includes a first and a second optical systems sharing the optical axis, the first optical system being capable of focusing the first and the second alignment marks, and the second optical system being capable of focusing the first and the second reference marks.

6. The alignment apparatus for a liquid-jet head according to claim 5 further comprising a plurality of bifocal microscopes which are disposed with the distance between their optical axes being equal to the distance between the alignment marks of two of the nozzle plates adjacent to each other so that the plurality of alignment marks formed respectively in the nozzle plates of the plurality of liquid-jet heads can be observed simultaneously.

7. The alignment apparatus for a liquid-jet head according to claim 5 further comprising:
a bifocal microscope with its optical axis being fixed; and
a space jig that supports the liquid-jet head,
wherein the mask and the spacer jig that are made to move as a unit so that the first and the second reference marks as well as the first and the second alignment marks, all of which are subjected to the alignment process, can occupy any one of the positions on the optical axis and in the vicinity of the optical axis.

8. An alignment method for a liquid-jet head in positioning relative to and joining with each other a nozzle plate and a fixation member, the nozzle plate including a nozzle orifice for injecting a liquid for the liquid-jet head, and a first and a second alignment marks to be used in an aligning operation, each of the alignment marks being formed in each of two end portions in the longitudinal direction of the nozzle plate, and the fixation member holding the nozzle-plate side of each of a plurality of liquid-jet heads, the method comprising:
an adjustment to make the first alignment mark overlap a first reference mark, with which the first alignment mark is to be aligned, by combining a linear movement of the liquid-jet head within a plane that is parallel to the nozzle plate and a rotational movement of the liquid-jet head about an axis orthogonal to the plane; and
another adjustment to make the second alignment mark overlap a second reference mark with which the second alignment mark is to be aligned.

9. The alignment method for a liquid-jet head according to claim 8 further comprising:
making the first alignment mark be aligned with the first reference mark by a linear movement of the liquid-jet head, and
making the second alignment mark be aligned with the second reference mark by a rotational movement of the liquid-jet head about an axis which passes on the center of the first reference mark, and which is orthogonal to the plane.
